(19) United States
(12) Patent Application Publication
(10) Pub. No.: US 2021/0365345 A1
(43) Pub. Date: Nov. 25, 2021

(54) DATA COLLECTION TO MONITOR DEVICES FOR PERFORMANCE

(71) Applicant: Hewlett-Packard Development Company, L.P., Spring, TX (US)

(72) Inventors: Gaurav Roy, Spring, TX (US); Amit Kumar Singh, Spring, TX (US); Mengqi Hei, Spring, TX (US); NileshKumar Gawali, Pune (IN); Aravind lyengar, Spring, TX (US); Padma Jangala, Spring, TX (US); Alok Bhatt, Pune (IN); Madhurya Sama, Pune (IN); Aleksei Shelaev, Spring, TX (US)

(73) Assignee: Hewlett-Packard Development Company, L.P., Spring, TX (US)

(21) Appl. No.: 17/047,498

(22) PCT Filed: Oct. 10, 2019
(86) PCT No.: PCT/US2019/055497

§ 371 Date: Oct. 14, 2020

(30) Foreign Application Priority Data
Oct. 15, 2018 (IN) 201841039125

(51) Int. Cl. G06F 11/34; G06F 16/901; G06F 11/30

(52) U.S. Cl. CPC G06F 11/3409; G06F 11/302; G06F 16/901

(57) ABSTRACT

An example of an apparatus including a communication interface to receive raw data from a client device. The raw data is to be collected by the client device. The apparatus further includes a filtering engine to remove portions of the raw data to generate filtered data. The apparatus also includes an analysis engine to process the filtered data to identify an application that reduces an overall performance. The apparatus also includes a memory storage unit to store a database. The database includes the raw data, the filtered data, a client device identifier, and an application identifier associated with the application.

### BACKGROUND

Various devices and apparatus may be part of a system for providing devices as a service. In such systems, devices are administered by a central server. As devices are used, various applications may be installed on each device to carry out tasks. Devices may operate many multiple applications simultaneously. Therefore, each device may allocate resources in order to allow the applications to properly function. Since each application may use a different amount of resources, some applications will use more resources than others which may slow the device.

### BRIEF DESCRIPTION OF THE DRAWINGS

Reference will now be made, by way of example only, to the accompanying drawings in which:

FIG. 1 is a block diagram of an example apparatus to monitor devices for performance;

FIG. 2 is a block diagram of an example device to monitor performance locally;

FIG. 3 is a flowchart of an example method of monitoring devices for performance by an apparatus in the cloud;

FIG. 4 is a block diagram of another example apparatus to monitor devices for performance;

FIG. 5 is a representation of an example system to monitor devices for performance by an apparatus in the cloud; and

FIG. 6 is a flowchart of an example dataflow during monitoring of device performance by an apparatus.

### DETAILED DESCRIPTION

Devices connected to a network may be widely accepted and may often be more convenient to use. In particular, new services have developed to provide devices as a service where a consumer simply uses the device while a service provider maintains the device and ensures that its performance is maintained at a certain level.

With repeated use of any device over time, the device uses various parts or components that may wear down over time and eventually fail. In addition, overall performance of the device may also degrade over time. The overall performance degradation of the device may be a combination of software performance degradation and hardware performance degradation. While measuring the overall performance of the device may be relatively easy, such as measuring processor capacity use or memory use, attributing the cause of a decrease in overall performance to either a software performance issue or a hardware performance issue may call for substantial testing and investigation. In particular, changing and upgrading applications on a device may be a cause for degradation of the overall performance over time on a device. The specific cause of the performance degradation may also not be readily identifiable. For example, in some cases, the performance degradation may be a result of hardware issues, software issues, or a combination of both.

Even if the performance degradation is determined to be a software issue, determining the cause, such as a specific application causing the performance degradation, may call for extensive testing and down time for a device. In addition, not all applications may result in the same overall performance degradation across devices. Furthermore, software degradation may not be dependent on the application and instead be dependent on a specific device such as when there is an underlying hardware issue. For example, as physical degradation of a component may result something that appears to be a software issue. In other examples, the overall performance degradation may be dependent on a combination of the application and the device.

Accordingly, applications may be rated to identify applications that may decrease the overall performance of a device. The manner by which an application is identified is not limited and may include various algorithms or may involve presentation of the data on a display for an administrator to evaluate. Similarly, devices may be rated to identify devices having a lower overall performance. The manner by which the devices is identified is not limited and may include various algorithms or presentation of the data on a display for an administrator to evaluate.

Once the application affecting overall performance or devices that have decreased overall performance have been identified, corrective actions may be taken. For example, if a specific application is identified to degrade the overall performance across a wide variety of devices, the application may be removed from devices where possible and/or replaced with similar applications which may have a smaller effect on the overall performance of the device. Similarly, devices that may be identified as having degraded overall performance may be retired and replaced with new devices.

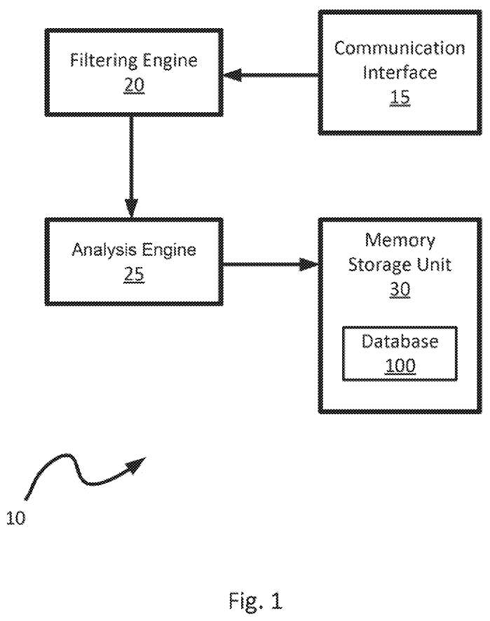

Referring to FIG. 1, an example of an apparatus to monitor devices for performance is generally shown at 10. The apparatus 10 may include additional components, such as various interfaces to communicate with other devices, and further input and output devices to interact with an administrator with access to the apparatus 10. In the present example, the apparatus 10 includes a communication interface 15, a filtering engine 20, an analysis engine 25, and a memory storage unit 30 maintaining a database 100. Although the present example shows the filtering engine 20 and the analysis engine 25 as separate components, in other examples, the filtering engine 20 and the analysis engine 25 may be part of the same physical component such as a microprocessor configured to carry out multiple functions.

The communications interface 15 is to communicate with devices over a network. In the present example, the apparatus 10 may be in the cloud to manage a plurality of devices. In the present example, the devices may be client devices of a device as a service system. Accordingly, the communications interface 15 may be to receive message packets having data from several different client devices which are managed by the apparatus 10. In the present example, the data may be raw data collected from each device to indicate of the usage of resources being on the device. For example, the raw data may include data such as a percentage of processor capacity usage or a percentage of memory use to measure the overall performance of the device. The manner by which the communications interface 15 receives the raw data is not particularly limited. In the present example, the apparatus 10 may be a cloud server located at a distant location from the devices which may be broadly distributed over a large geographic area. Accordingly, the communications interface 15 may be a network interface communicating over the internet in this example. In other examples, the communication interface 15 may connect to the devices via a peer to peer connection, such as over a wire or private network.

In the present example, the raw data collected is not particularly limited. For example, the raw data may include system device information, such as account name, model, manufacturer, born on date, type, etc., hardware information, such as smart drive information, firmware revision, disk physical information like model, manufacturer, self-test results, and processor usage statistics. The raw data may be collected using a background process running locally at the device carried out by a diagnostic engine. The background process may use a small amount of resources such that it does not substantially affect foreground processes running on the device. The raw data may be also collected by the diagnostic engine and received by the communications interface 15 periodically, such as at regularly scheduled intervals. For example, the raw data may be received once a day. In other examples, the raw data may be received more frequently, such as every hour, or less frequently, such as every week.

The filtering engine 20 is to remove portions of the raw data received from each of the devices to generate filtered data to be subsequently processed. In the present example, the filtering engine may remove portions of the raw data collected from the devices associated with anomalous events. The anomalous events are not particularly limited and may include events that occur on the device that may not reflect the normal operation of the device. For example, some anomalous events may include a boot process, a shutdown process, an application startup process, or other event that may result in a temporary increase in memory use or processor capacity use. In other examples, portions of the raw data related to some applications may also be filtered out, such as applications which may be granted an exception. For example, some active applications running on the devices may be not be replaceable or omitted, such as client specific software for which there are no known alternatives. In further examples, some devices or device types may be exempted from any further analysis.

The manner by which portions of the raw data are removed is not particularly limited. In the present example, the raw data may include various information such as a device identifier, a process identifier, and information relating to the state of the device at the time of data collection. The information may be stored in the form of database structure that allows the filtering engine 20 to perform various queries to isolate certain portions of the raw data received via the communications interface 15. Accordingly, once portions of the database storing the raw data are isolated, the raw data may be used to generate a data table of filtered data. It is to be appreciated that by reducing the amount of data forwarded to the analysis engine 25, the amount of processing to be performed by the analysis engine 25 may be reduce. Therefore, the monitoring process of the devices becomes more efficient by removing irrelevant data collected by the device. In examples where the filtering engine 20 removes portions of the raw data associated with anomalous events, the analysis engine 25 may be able to process the data more effectively to identify applications or devices for further consideration to increase performance.

The analysis engine 25 is to process the filtered data from the filtering engine 20. In particular, the analysis engine 25 is to use the filtered data to identify the cause of a reduction in the overall performance of a device. In the present example, the cause may be a specific application running on the device. The application may further cause the overall performance of multiple devices to decrease in some examples, whereas in other examples, the application may cause the overall performance of a subset of the devices to decrease while having no effect on other devices. In the present example, the precise mechanism by which an application degrades the overall performance of a devices is not particularly important. Instead, the analysis engine 25 looks at the empirical data to determine the circumstances under which a decrease in the overall performance is observed based on the raw data received from the devices. In some examples, the analysis engine 25 may determine a specific device or a type or group of similar devices where the overall performance is chronically slow. Accordingly, in this example, the analysis engine 25 may identify a device instead of an application.

In the present example, the analysis engine 25 processes filtered data associated with multiple devices. Although each of the multiple devices may be running different combinations of applications, a common application among the devices may be found to significant decrease the overall performance of the devices. In this present example, the analysis engine 25 may identify applications after performing an evaluation on the filtered data to measure the decrease in the overall performance on a device, such as an available processor capacity or an available percentage of memory.

In some examples, the overall performance may be compared against a threshold performance to determine if the overall performance meets the threshold performance. Accordingly, the analysis engine 25 may identify multiple applications that do not meet the threshold performance. It is to be appreciated that the threshold performance is not limited and may be determined using a variety of different methods. For example, the threshold performance may be a set as a percentage of processor capacity available, a percentage of memory available, or a combination of both. In other examples, the threshold performance may be set as an absolute amount of processor operations being to be performed or an absolute amount of memory being used to account for devices with different capacities.

The memory storage unit 30 is configured to maintain a database 100 based on the results of the analysis engine 25. The manner by which the memory storage unit 30 stores or maintains the database 100 is not particularly limited. In the present example, the memory storage unit 30 may maintain a table in the database 100 to store the various data including the raw data received by the communication interface 15, the filtered data generated by the filtering engine 20, and information associated with the results from the analysis engine 25. The results from the analysis engine generally identify an application that causes a decrease in the overall performance of a device. In other examples, the results from the analysis engine 25 may also identify a device with decreased overall performance.

Accordingly, it is to be appreciated that the results of the analysis engine 25 may be store in the database 100 and may include a device identifier and/or an application identifier associated with the application identified by the analysis engine 25. The information in the database 100 may then be used to carry out corrective actions to improve the overall performance of a device. For example, if an application is identified to be cause a decrease in the overall performance of a device, the application may be removed from the device. In addition, the application may be removed from other devices in the device as a service system with the same application. In some cases where the removal of the application is impractical, a replacement application or an upgrade to the application or the device running the application may be implemented to alleviate the decrease in the overall performance of a device. In other examples where a device with decreased overall performance is identified, the device may be deactivated and removed from the device as a service system (i.e. retired) to improve the performance of the device as a system as a whole. A replacement device may also be ordered or delivered to the user of the deactivated device.

In the present example, the memory storage unit 30 may include a non-transitory machine-readable storage medium that may be, for example, an electronic, magnetic, optical, or other physical storage device. In addition, the memory storage unit 30 may store an operating system that is executable by a processor to provide general functionality to the apparatus 10. For example, the operating system may provide functionality to additional applications. Examples of operating systems include Windows™ macOS™, OS™, Android™, Linux™ and Unix™. The memory storage unit 30 may additionally store instructions to operate at the driver level as well as other hardware drivers to communicate with other components and peripheral devices of the apparatus 10.

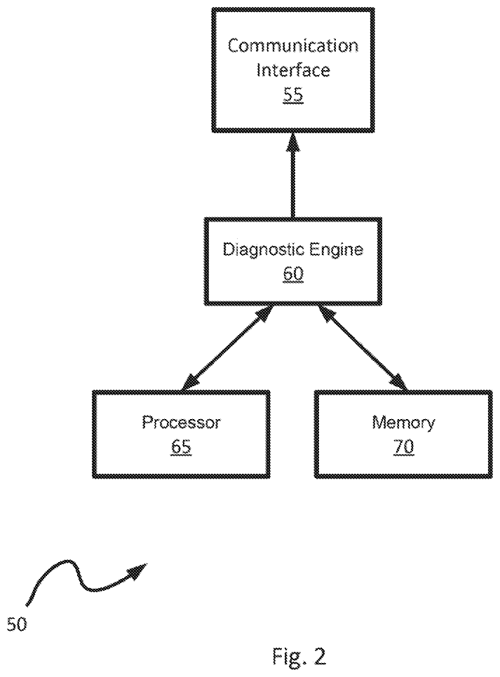

Referring to FIG. 2, an example of a device of a data collection system is generally shown at 50. The device 50 may be a client device or any other device connected to the apparatus 10, such as a shared device like a scanner or printer. The device 50 may include additional components, such as various memory storage units and interfaces to communicate with other devices. The device 50 may also include peripheral input and output devices to interact with a user. In the present example, the device 50 includes a communication interface 55, a diagnostic engine 60, a processor 65 and a memory storage unit 70. Although the present example shows the diagnostic engine 60 and the processor 65 as separate components, in other examples, the diagnostic engine 60 and the processor 65 may be part of the same physical component. For example, the diagnostic engine 60 may be part of the processor 65.

The communications interface 55 is to communicate with the apparatus 10 over a network. In the present example, the device 50 may be connected to a cloud network and may be managed by the apparatus 10 via the cloud network. Accordingly, the communications interface 55 may be to transmit raw data collected by the diagnostic engine 60 for further processing by the apparatus 10. The manner by which the communications interface 55 transmits the raw data is not particularly limited. In the present example, the device 50 may connect with the apparatus 10 at a distant location over a network, such as the internet. In other examples, the communication interface 55 may connect to the apparatus 10 via a peer to peer connection, such as over a wire or private network. In the present example, the apparatus 10 may be a central server. However, in other examples, the apparatus 10 may be substituted with a virtual server existing in the cloud where functionality may be distributed across several physical machines.

The diagnostic engine 60 is to carry out a diagnostic process on the processor 65 and the memory storage unit 70 of the device 50. In the present example, the diagnostic engine 60 periodically carries out the diagnostic process. In other examples, the diagnostic engine 60 may carry out the diagnostic process upon receiving a request from the apparatus 10 or other source via the communication interface 55. In the present example, the diagnostic engine 60 is to collect data using the diagnostic process on the processor 65 and the memory storage unit 70 of the device 50. The diagnostic process is to collect raw data relating to the processor 65 and the memory storage unit 70 of the device 50 using various measurements to generate raw data for the apparatus 10.

In particular, the diagnostic engine 60 is to collect raw data from the processor 65 and the memory storage unit 70 of the device 50. In other examples, the diagnostic engine 60 may also collect data from other components from such as batteries, displays, processors, applications, or other software running on the device 50. In the present example, the diagnostic engine 60 operates as a background process during normal operation of the device 50 to collect the raw data. The background process may use a small amount of processor resources such that the background process does not substantially affect foreground processes running on the device 50. The raw data may be automatically transmitted to the apparatus 10 via the communications interface 55 at regular intervals. For example, the raw data may be transmitted once a day from the device 50. In other examples, the raw data may be transmitted more frequently, such as every hour.

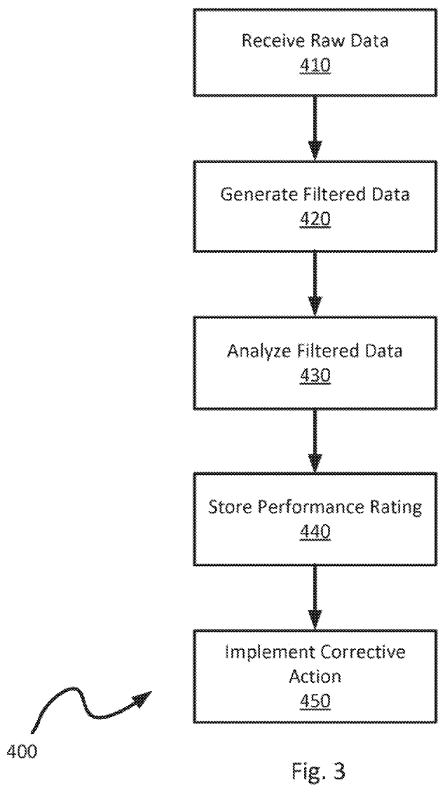

Referring to FIG. 3, a flowchart of an example method of hardware replacement prediction is generally shown at 400. In order to assist in the explanation of method 400, it will be assumed that method 400 may be performed by the apparatus 10 in communication with a device 50. Indeed, the method 400 may be one way in which apparatus 10 may be configured to interact with devices. Furthermore, the following discussion of method 400 may lead to a further understanding of the apparatus 10 and the device 50. In addition, it is to be emphasized, that method 400 may not be performed in the exact sequence as shown, and various blocks may be performed in parallel rather than in sequence, or in a different sequence altogether.

Beginning at block 410, raw data is received from a plurality of devices. In the present example, the raw data includes information associated with an application running on each of the devices from which the apparatus 10 is to receive raw data. In particular, the raw data may include information associated with all the applications running on each of the devices. In other examples, the raw data may include information associated with some application running on each device. Furthermore, it is to be appreciated that each device may be running different applications such that the combination of information about applications received from each device may be different.

In the present example, the raw data is collected from the processor 65 and the memory storage unit 70. The diagnostic engine 60 may be used to collect the raw data using a background process. In other examples, the diagnostic engine 60 may further collect raw data from other components such as batteries, displays, applications, or other software running on the device 50. The background process carried out by the diagnostic engine 60 may use a relatively small amount of processor resources such that the background process does not substantially affect foreground processes running on the device 50. Accordingly, a user of the device 50 may not notice that raw data is being collected during normal use of the device 50. In some examples, the apparatus 10 may receive raw data collected at predetermined time intervals by each device 50 regularly. For example, the raw data may be received once a day from each of the devices 50. In other examples, the raw data may be received more frequently, such as every hour or every fifteen minutes, to detect changes more rapidly for systems that call for a faster response time. Alternatively, the raw data may be received less frequently, such as every week, for more stable systems or systems that do not call for such a fast response time. In other examples, the apparatus 10 may receive raw data continuously, at random times, or upon a request from the apparatus 10 to each device. It is to be appreciated that in some examples, the apparatus 10 may receive raw data in accordance with a different schedule for different devices 50 managed by the apparatus 10.

In the present example, the raw data may be collected from each device 50 to indicate of the usage of resources being on the device 50. For example, the raw data may include information such as a percentage of processor capacity usage or a percentage of memory use. The manner by which the apparatus 10 receives the raw data is not particularly limited. In the present example, the apparatus 10 may be a cloud server located at a distant location from each of the devices 50 which may be broadly distributed over a large geographic area. Accordingly, the apparatus 10 may use existing infrastructure such as the internet. In other examples, the apparatus 10 may connect to the devices via a peer to peer connection, such as over a wired or private network.

Block 420 involves generating filtered data by removing data associated with anomalous events in the raw data from each of the devices 50. The anomalous events are not particularly limited and may include events that occur on the device 50 that may not reflect the normal operation of the device 50. For example, some anomalous events may include a boot process, a shutdown process, an application startup process, or other event that may result in a temporary increase in memory use or processor capacity use. In other examples, portions of the raw data from the device 50 related to some specific applications may also be filtered out, such as applications which may be granted an exception. For example, some applications running on the device 50 may be exempted from analysis by an administrator or designer of the system, such as client specific software for which there are no known alternatives. In further examples, some devices or device types may be exempted from any further analysis as well such that raw data received from these devices 50 may not be further processed.

Next, block 430 involves analyzing the filtered data generated at block 420 to determine an average performance rating of an application. The manner by which the average performance rating of the application is determined is not particularly limited. In the present example, filtered data from raw data received from multiple devices 50 running the application is analyzed. It is to be appreciated that at any point in time, not all devices 50 may be running the application. Accordingly, the analysis engine 25 may look at historical filtered data from devices 50 that may have operated the application in question. The analysis engine may assign an average performance rating for the application based on the analysis of the collected filtered data. In the present example, the average performance rating may be a assigned an index number for subsequent comparisons against other applications where a higher index number indicates a more efficient application. In other examples, the actual data, such as the amount of processor resources (measured in operations), or amount of memory space used (measured in bytes) may be used to represent the average performance rating for the application.

In the present example, it is to be appreciated that as more filtered data is generated at block 420, the average performance rating for an application may drift or change. For example, if subsequent changes in the operating system or hardware upgrades to the device are implemented, the average performance rating may increase if the application exploits new features, or the average performance rating may decrease if the application does not adapt to the new operating environment. In other examples, the average performance rating may be calculated for a single point in time from scratch.

In some examples, multiple applications may be ranked based on the average performance rating. The manner by which the applications are ranked is not particularly limited. For example, the applications may be ranked by strictly sorting the applications in the order of each application's average performance rating. In other examples where the average performance rating may include multiple types of data where one type of data may be used to rank the applications.

Block 440 involves storing the average performance rating of each application in a database 100. In particular, the database 100 may be a single database located in the memory storage unit 30 of the apparatus 10. It is to be appreciated that this provides a central location from which queries may be submitted to determine which applications decrease the overall performance of the devices to the greatest extent. This information may then be used for subsequent planning, such as to phase out the applications that rank high decreasing the overall performance of a device. In other examples, the database 100 may be mined by to render visual representation of that run on the devices 50.

Block 450 involves implementing a corrective action to increase overall performance of the device 50 based on contents of the database. For example, if an application is identified to be cause a decrease in the overall performance of a device 50, the application may be removed from the device. In addition, the application may be removed from other devices in the device as a service system with the same application. In some cases where the removal of the application is impractical, a replacement application or an upgrade to the application or the device 50 running the application may be implemented to alleviate the decrease in the overall performance of the device 50. In other examples where a device with decreased overall performance is identified, the device may be deactivated and removed from the device as a service system (i.e. retired) to improve the performance of the device as a system as a whole. A replacement device may also be ordered or delivered to the user of the deactivated device.

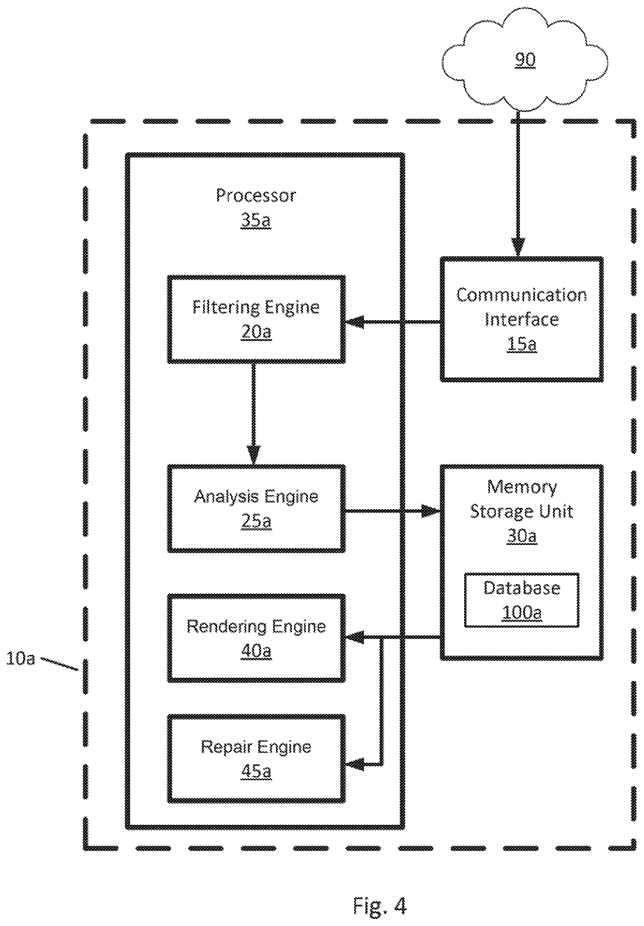

Referring to FIG. 4, another example of an apparatus to monitor devices for performance is generally shown at 10a. Like components of the apparatus 10a bear like reference to their counterparts in the apparatus 10, except followed by the suffix “a”. The apparatus 10a includes a communication interface 15a to communicate with a network 90, a filtering engine 20a, an analysis engine 25a, a rendering engine 40a, a repair engine 45a, and a memory storage unit 30a maintaining a database 100a. In the present example, the filtering engine 20a, the analysis engine 25a, and the rendering engine 40a are implemented by a processor 35a. Although the present example shows the processor 35a operating various components, in other examples, multiple processors may also be used. The processors may also be virtual machines in the cloud that may actually be a different physical machine with each implementation of the filtering engine 20a, the analysis engine 25a, the rendering engine 40a, and the repair engine 45a.

The processor 35a may include a central processing unit (CPU), a graphics processing unit (GPU), a microcontroller, a microprocessor, a processing core, a field-programmable gate array (FPGA), an application-specific integrated circuit (ASIC), or similar. The processor 35a and the memory storage unit 30a may cooperate to execute various instructions. The processor 35a may execute instructions stored on the memory storage unit 30a to carry out processes such as the method 400. In other examples, the processor 35a may execute instructions stored on the memory storage unit 30a to implement the filtering engine 20a, the analysis engine 25a, and the rendering engine 40a. In other examples, the filtering engine 20a, the analysis engine 25a, and the rendering engine 40a may each be executed on a separate processor. In further examples, the filtering engine 20a, the analysis engine 25a, and the rendering engine 40a may be operated on a separate machine, such as from a software as a service provider or in a virtual cloud server as mentioned above.

The rendering engine 40a is to render output, such as a visualization in the form of a list, a chart, or a graph, based on the contents of the database 100a. In particular, the rendering engine 40a is to generate output including a plurality of applications to be displayer to a user. The specific format of the output rendered by the rendering engine is not limited. For example, the apparatus 10 may have a display (not shown) to receive signals from the rendering engine 40a to display various tables and/or charts having organized information related to the plurality of applications. In other example, the rendering engine 40a may generate reports and/or charts in electronic form to be transmitted to an external device for display. The external device may be a computer of an administrator, or it may be a printing device to generate hardcopies of the results.

In the present example, the rendering engine 40a may also rank each application in the database 100 based on an amount that the overall performance of a device is reduced. In other examples, an average performance rating may be calculated and the applications may be ranked in order of their respective average performance ratings. Therefore, the rendering engine 40a may display the ordered list to a user or administrator. The rendering engine 40a may also allow for input to be received to further manipulate the data. For example, a user may apply various filters to the information in the database 100a to generate lists, tables, and/or charts for comparisons between multiple applications. Therefore, the rendering engine 40a is to generate visual displays automatically from the database 100a to provide for meaningful comparisons when an administrator is to make changes to the system, such as renewing licenses with existing applications or selecting applications to drop from an approved list of applications.

The repair engine 45a is to implement a corrective action in response to the information in the database 100a to increase the overall performance of a device or of the device as a service system. The manner by which the repair engine 45a implements the corrective action is not particularly limited and may depend on various factors. For example, a threshold value for an average performance rating may be set such than any application with a performance rating below the threshold (i.e. an inefficient program) may be removed, deactivated, upgraded, or replaced with an alternative application to improve performance of a device. In another example, the repair engine 45a may compare a percentage of processor capacity usage or a percentage of memory use to determine a corrective action. In yet another example where a device is determined to have been degraded, the repair engine 45a may deactivate the device from a device as a service system such that the device will be replaced.

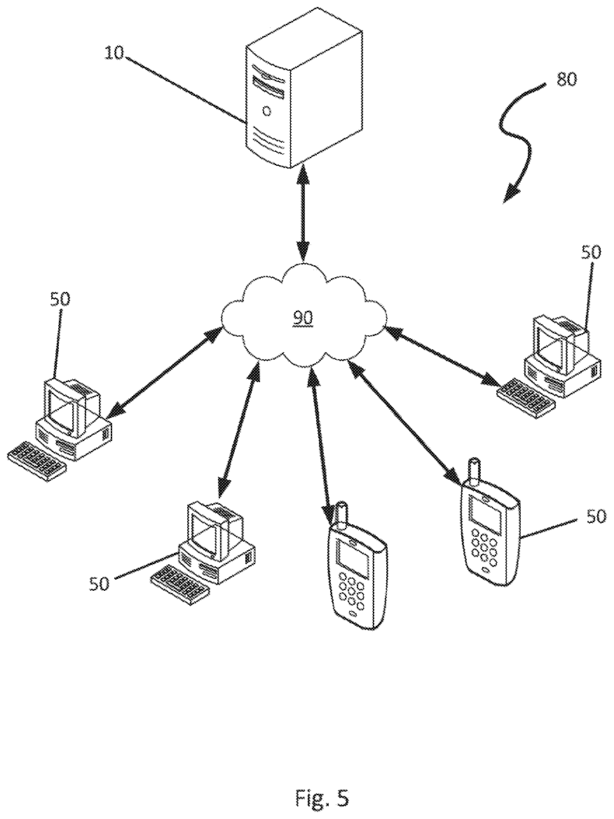

Referring to FIG. 5, an example of a system to monitor devices for overall performance generally shown at 100. In the present example, the apparatus 10 is in communication with a plurality of devices 50 via a network 90. It is to be appreciated that the devices 50 are not limited and may be a variety of devices 50 managed by the apparatus 10. For example, the device 50 may be a personal computer, a tablet computing device, a smart phone, or laptop computer. In the present example, the devices 50 each run a plurality of applications. It is to be appreciated that since the devices 50 are all managed by the apparatus 10, the devices 50 may be expected to have overlapping applications where more than one device 50 is running an application. Although five devices 50 are illustrated in FIG. 5, it is to be appreciated that the system 80 may include more devices 50. For example, the system 80 may include hundreds or thousands of devices 50.

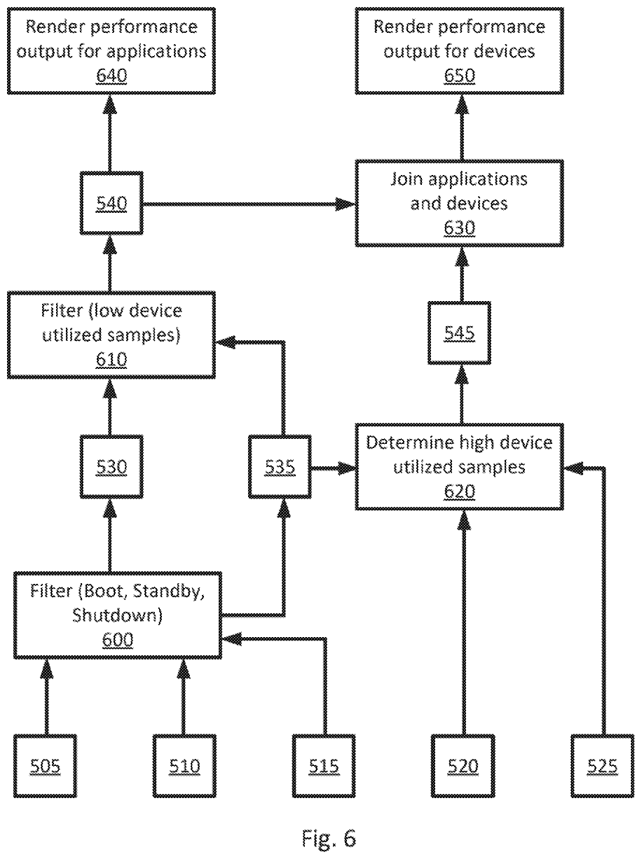

Referring to FIG. 6, an example of the flow of data is shown. In order to assist in the explanation of the flow of data, it will be assumed that from a device 50 to the apparatus 10. Indeed, the data flow may be one way in which apparatus 10 and/or the devices 50 may be configured to interact with each other.

As discussed above, each device 50 includes a diagnostic engine 60 to collect raw data. In the present example, the raw data includes data about application performance data 505, system monitor data 510, anomalous event data 515, device information 520, and company information 525. In the present example, a parallel handling of data is carried out. In one stream, the apparatus 10 carries out the steps describe above in connection with evaluating overall performance at the device 50 based on applications that may be running. In another stream, the apparatus 10 carries out the steps to monitor devices 50 specifically irrespective of what applications may be running on the device 50 at any given time.

It is to be appreciated that the application performance data 505 and the system monitor data 510 includes information pertaining to the overall performance of the device 50. By contrast, the device information 520 and the company information 525 are static information that is no to be changed unless the device 50 is repurposed. Accordingly, information from the application performance data 505 and the system monitor data 510 along with the anomalous event data 515 (e.g. information pertaining to boot time, shutdown, and standby information) is forwarded to the filtering engine 20, where the filter applies the information from the anomalous event data 515 to the application performance data 505 and the system monitor data 510 to generate of a list of applications 530 and to generate a list of devices performing below average 535 at block 600.

The list of applications 530 is further processed by the filtering engine 20 to remove low device utilized samples from consideration at block 610. It is to be appreciated that a device may include applications not used by over a long period of time which may skew the analysis. In the present example, the list of devices performing below average 535 is also sent to the filtering engine 20 to provide additional context when determining whether an application is to be filtered out. Block 610 subsequently generates a report 540 of the applications that cause a device to perform below average. Subsequently, the report 540 may be rendered for output by the rendering engine to display the applications have an average performance rating below a threshold value at block 640.

Turning to the device monitoring stream, the device information 520 and company information 525 is combined with the list of devices performing below average 535. At block 620, the analysis engine 25 may then use this data to generate a report 545 of the devices 50 that exhibit high processor usage or a high percentage of memory use.

In some examples, the report 540 and the report 545 may be joined at block 630. Once the report 540 and the report 545 are joined, the rendering engine 40a may be used to output both applications and devices that have caused the slow-down and block 650.

Various advantages will now become apparent to a person of skill in the art. For example, the system 80 may benefit from having a simple and effective way to monitor for applications and/or devices that may reduce the performance at a device such that administrators may readily design and plan for alternatives. As another example of an advantage, the method 400 also takes into account the anomalous events that may otherwise affect the analysis of the effect an application may have on the performance of a device 50.

It should be recognized that features and aspects of the various examples provided above may be combined into further examples that also fall within the scope of the present disclosure.

What is claimed is:

1. An apparatus comprising:
a communication interface to receive raw data from a client device, wherein the raw data is collected by the client device;
a filtering engine to remove portions of the raw data to generate filtered data;
an analysis engine to process the filtered data to identify an application, wherein the application reduces an overall performance; and
a memory storage unit to store a database, wherein the database includes the raw data, the filtered data, a client device identifier, and an application identifier associated with the application, and wherein contents of database is to be used to implement a corrective action to increase overall performance of the client device.

2. The apparatus of claim 1, wherein the corrective action is to remove the application from the client device.

3. The apparatus of claim 1, wherein the filtering engine removes portions of the raw data associated with anomalous events.

4. The apparatus of claim 3, wherein the communication interface receives the raw data collected by a diagnostic engine periodically.

5. The apparatus of claim 4, wherein the analysis engine, wherein the analysis engine identifies the application based on an evaluation of the overall performance against a threshold performance.

6. The apparatus of claim 5, further comprising a rendering engine to render a visualization based on the database, wherein the visualization compares an average performance rating of the application against average performance ratings of additional applications.

7. The apparatus of claim 1, wherein the overall performance is measured by processor capacity use by the application.

8. The apparatus of claim 1, wherein the overall performance is measured by memory use by the application.

9. A method comprising:
receiving raw data from a plurality of client devices, wherein the raw data is associated with an application active on each client device of the plurality of client devices;
generating filtered data via removal of data associated with anomalous events in the raw data;
analyzing the filtered data to determine an average performance rating of the application;
storing the average performance rating of the application in a database; and
implementing a corrective action to increase overall performance of the plurality of client devices based on contents of the database.

10. The method of claim 9, wherein implementing the corrective action comprises removing the application from the plurality of client devices.

11. The method of claim 10, wherein receiving the raw data comprises receiving the raw data at predetermined time intervals from each client device of the plurality of client devices.

12. The method of claim 11, wherein storing comprises updating the average performance rating of the application over time.

13. The method of claim 11, further comprising generating a visualization on a display to indicate the average performance rating of the application.

14. A non-transitory machine-readable storage medium encoded with instructions executable by a processor, the non-transitory machine-readable storage medium comprising:
instructions to receive raw data from a plurality of client devices, wherein the raw data is associated with an application active on each client device of the plurality of client devices;
instructions to filter the raw data to remove of data associated with boot processes, shutdown processes and standby processes;
instructions to determine an average performance rating of the application based on filtered data;
instructions to render the application and the average performance rating of the application on a display; and
instructions to implement a corrective action to increase overall performance of the client device based on the average performance rating.

15. The non-transitory machine-readable storage medium of claim 14, wherein the instructions to render the application and the average performance rating of the application comprises generating a chart to compare the application against additional applications.
